(19) United States
(12) Patent Application Publication
(10) Pub. No.: US 2016/0342410 A1
(43) Pub. Date: Nov. 24, 2016

(54) METHOD AND APPARATUS FOR PROCESSING APPLICATION INSTALLATION PACKAGE

(71) Applicant: Xiaomi Inc., Beijing (CN)

(72) Inventors: Junzhou WU, Beijing (CN); Shujie WANG, Beijing (CN); Nian SUN, Beijing (CN)

(73) Assignee: Xiaomi Inc.

(21) Appl. No.: 15/160,746

(22) Filed: May 20, 2016

(30) Foreign Application Priority Data
May 22, 2015 (CN) 201510266977.2

(51) Int. Cl. G06F 9/445; G06F 9/45

(52) U.S. Cl. CPC G06F 8/65; G06F 8/41

(57) ABSTRACT

A method for processing an application installation package includes: acquiring a processing attribute of the application installation package when it is detected that an operation system of a mobile terminal is being upgraded with the application installation package, the processing attribute including one of an upgrade compilation attribute or an idle compilation attribute; and during upgrade of the operation system, compiling the application installation package having the upgrade compilation attribute.

### CROSS-REFERENCE TO RELATED APPLICATIONS

This application is based upon and claims priority to Chinese Patent Application No. 201510266977.2, filed on May 22, 2015, the entire contents of which are incorporated herein by reference.

### TECHNICAL FIELD

The present disclosure relates to the field of mobile terminals, and more particularly, to a method and an apparatus for processing an application installation package.

### BACKGROUND

During system upgrade of an Android system, it may be necessary to optimize the APK (Android Package) on a mobile terminal. In Android 5.0 or a later version, the optimization process is generally to compile the APK installed on the mobile terminal into binary codes, so as to increase the execution efficiency of the codes.

### SUMMARY

According to a first aspect of the present disclosure, there is provided a method for processing an application installation package. The method includes: acquiring a processing attribute of the application installation package when it is detected that an operation system of a mobile terminal is being upgraded with the application installation package, the processing attribute including one of an upgrade compilation attribute or an idle compilation attribute; and during upgrade of the operation system, compiling the application installation package having the upgrade compilation attribute.

According to another aspect of the present disclosure, there is provided an apparatus for processing an application installation package. The apparatus includes: a processor; and a memory for storing instructions executable by the processor. The processor is configured to: acquire a processing attribute of the application installation package when it is detected that an operation system of a mobile terminal is being upgraded with the application installation package, the processing attribute including one of an upgrade compilation attribute or an idle compilation attribute; and during upgrade of the operation system, compile the application installation package having the upgrade compilation attribute.

According to another aspect of the present disclosure, there is provided a non-transitory computer-readable storage medium having stored therein instructions that, when executed by one or more processors of an apparatus, cause the apparatus to perform: acquiring a processing attribute of the application installation package when it is detected that an operation system of a mobile terminal is being upgraded with the application installation package, the processing attribute including one of an upgrade compilation attribute or an idle compilation attribute; and during upgrade of the operation system, compiling the application installation package having the upgrade compilation attribute.

It shall be appreciated that the above general description and the detailed description hereinafter are only illustrative and interpretative, but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the description, serve to explain the principles of the present disclosure.

FIG. 1 is a flowchart illustrating a method for processing an application installation package according to an exemplary embodiment.

FIG. 2A is a flowchart illustrating another method for processing an application installation package according to another exemplary embodiment.

FIG. 2B is a flowchart illustrating steps in step 201 shown in FIG. 2A.

FIG. 3A to FIG. 3C illustrate a mobile terminal having a display displaying user interface pages consistent with embodiments of present disclosure.

FIG. 4 is a block diagram illustrating an apparatus for processing an application installation package according to an exemplary embodiment.

FIG. 5 is a block diagram illustrating another apparatus for processing an application installation package according to another exemplary embodiment.

FIG. 6 is a block diagram illustrating another apparatus for processing an application installation package according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

A mobile terminal consistent with embodiments of the present disclosure may be a mobile phone, a tablet computer, an e-book reader, an MP3 player (Moving Picture Experts Group Audio Layer III), an MP4 (Moving Picture Experts Group Audio Layer IV 4) player, a portable laptop computer, and the like.

During upgrade of an operation system of a mobile terminal, the compilation process of each APK may take a few seconds to several minutes. Since the user may install multiple APKs in the mobile terminal, when all of APKs are to be compiled, the entire upgrade process may take a relatively long time. In a mobile phone having a less hardware resource, the entire upgrade process will last tens of minutes.

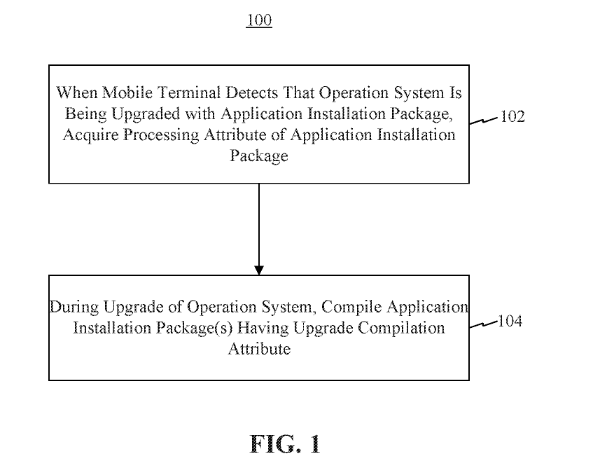

FIG. 1 is a flowchart illustrating a method 100 for processing application installation packages according to an exemplary embodiment. The method 100 can be performed by a mobile terminal. The method 100 includes the following steps.

In step 102, when the mobile terminal detects that an operation system is being upgraded with an application installation package, it acquires a processing attribute of the application installation package. The processing attribute includes one of an upgrade compilation attribute or an idle compilation attribute. In some embodiments, the operation system may be an Android operation system or other operation systems for mobile terminals.

In step 104, during upgrade of the operation system, the mobile terminal compiles the application installation package(s) having the upgrade compilation attribute.

In the illustrated embodiment, the processing attributes of application installation packages are acquired so that the application installation packages can be compiled according to their processing attributes. For example, an application installation package of an application that is less frequently used in the mobile terminal may be marked by a processing attribute to show the upgrade of the application may be postponed so that the application installation package may be compiled at a later time. The method 100 can overcome the problem in the conventional art that the upgrade of software system of a mobile terminal takes a long time when all of application installation packages are compiled during upgrade, and shorten the time required to upgrade/update the software system. Further, the method 100 reduces the impact to the user's normal use of the mobile terminal while it is compiling the application installation packages.

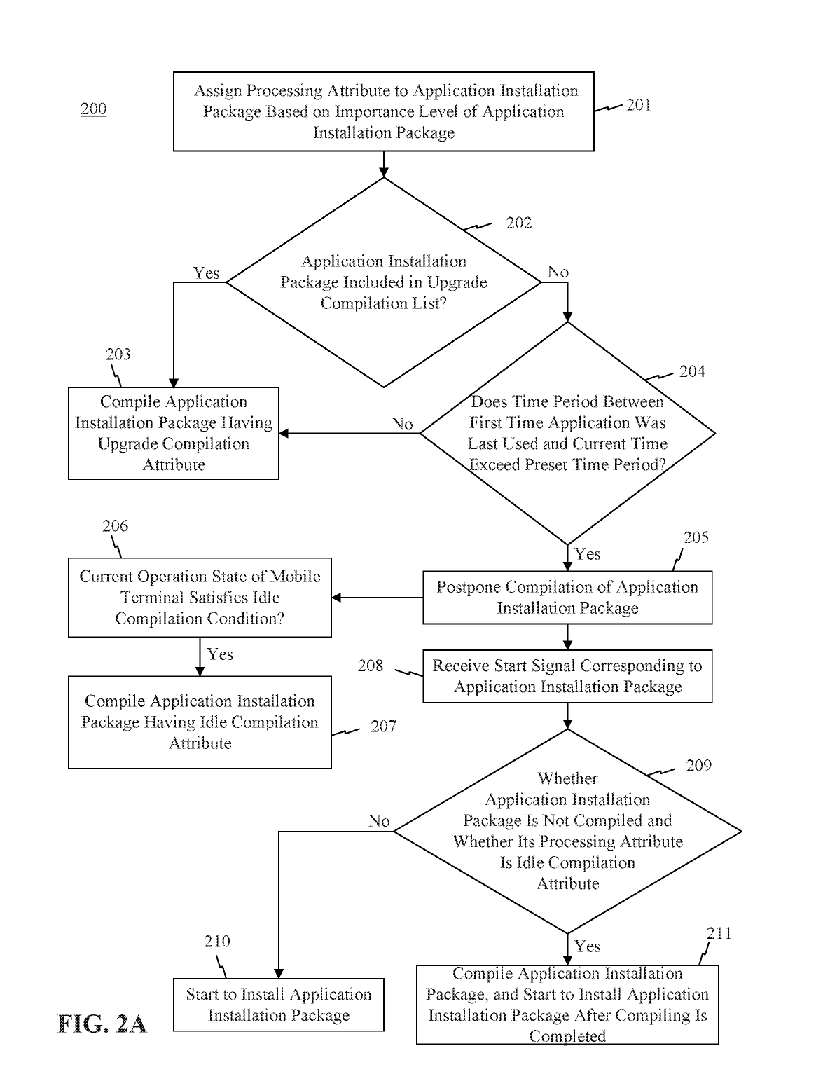

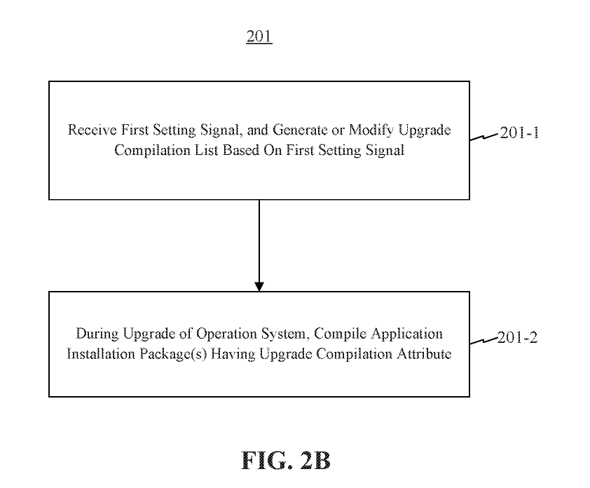

FIG. 2A is a flowchart illustrating a method 200 for processing application installation packages according to another exemplary embodiment. The method 200 may be performed by a mobile terminal. The method 200 includes the following steps.

In step 201, the mobile terminal assigns a processing attribute to an application installation package based on an importance level of the application installation package.

In one embodiment, the mobile terminal is a terminal on which the Android operation system is running. The application installation package is an APK.

The processing attribute includes an upgrade compilation attribute or an idle compilation attribute. The upgrade compilation attribute indicates that the application installation package needs to be compiled during current software upgrade/update event; the idle compilation attribute indicates that the application installation package may be compiled at a later time.

The importance level of the application installation package may be assigned by the operation system or a user of the mobile terminal. In some embodiments, application installation packages of applications necessary for running the operation system or frequently used by the user are assigned a high priority level, e.g., an upgrade compilation attribute; application installation packages of applications unnecessary for running the operation system or less frequently used by the user are assigned a low priority level, e.g., idle compilation attribute. In some embodiments, a usage frequency of an application, or a time duration from the time the application was last used to the current time, may be employed to indicate whether the application is frequently used by the user.

In some embodiments, the processing attribute of the application installation packages with a high priority level may be set as the upgrade compilation attribute. The processing attribute of the application installation packages with a low priority level may be set as the idle compilation attribute.

The processing attribute may be a static attribute, which may not be changed, or a dynamical attribute, which may be modified by, for example, the mobile terminal or an internet server.

When the processing attribute is a dynamical attribute modifiable by the mobile terminal, the step 201 further includes the following two steps.

Referring to FIG. 2B, in step 201-1, the mobile terminal receives a first setting signal, and generates or modifies an upgrade compilation list based on the first setting signal.

A user of the mobile terminal may trigger the generation of the first setting signal in the mobile terminal. The first setting signal may be, for example, a selecting signal in an APK list.

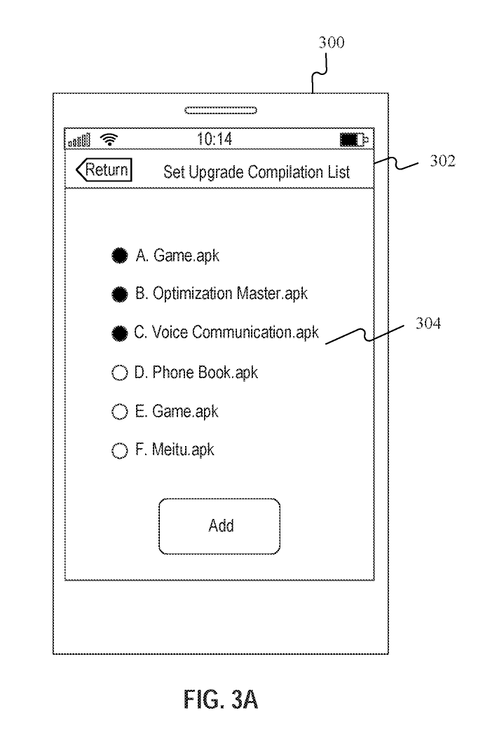

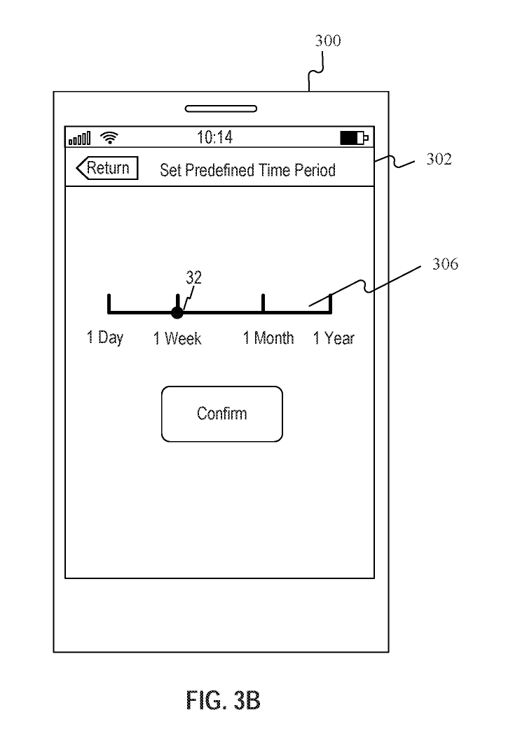

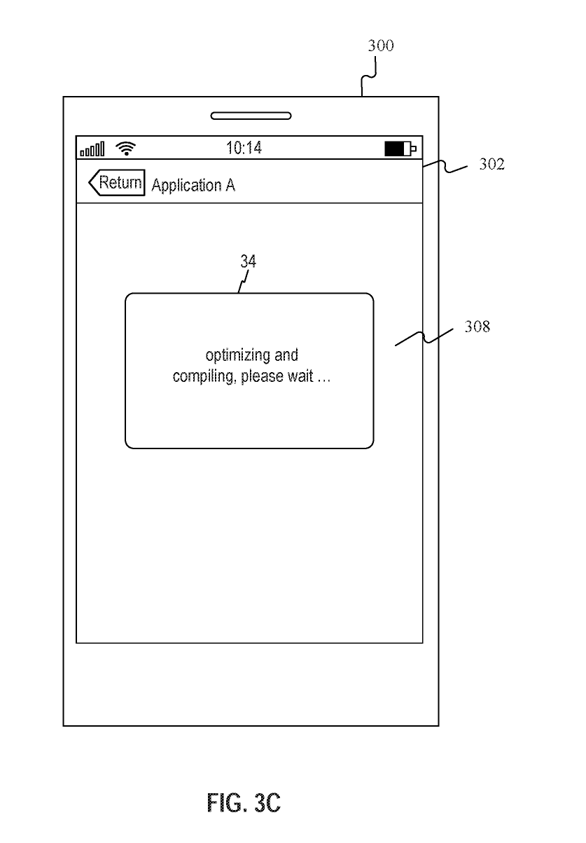

For example, FIG. 3A illustrates a mobile terminal 300 having a display 302 displaying an APK list 304. As shown in FIG. 3A, to generate the first setting signal, items, “A. Game.apk,” “B. Optimization Master. apk,” and “C. Voice Communication.apk,” are selected by the user to be added to the upgrade compilation list. The upgrade compilation list includes a list of application installation packages having the upgrade compilation attribute.

When an upgrade compilation list does not exist, the mobile terminal generates an upgrade compilation list based on the first setting signal; when the upgrade compilation list exists, the mobile terminal modifies the upgrade compilation list based on the first setting signal.

In some embodiments, an initial upgrade compilation list is preset by the operation system.

In step 201-2, the mobile terminal receives a second setting signal, and generates or modifies a preset time period based on the second setting signal.

The preset time period is a threshold for judging whether an application corresponding to the application installation package is a frequently used in the mobile phone. The user may trigger the generation of the second setting signal in the mobile terminal. The second setting signal may be a signal selected in a duration slider.

For example, FIG. 3B illustrates the mobile terminal 300 having the display 302 displaying duration slider 306. As shown in FIG. 3B, to generate the second setting signal, a sliding button 32 in a duration slider is moved horizontally to set a preset time period as one week. The preset time period is a threshold for judging whether an application corresponding to the application installation package is a frequently used in the mobile phone.

When the preset time period does not exist, the mobile terminal generates a preset time period based on the second setting signal; when the preset time period exists, the mobile terminal modifies the preset time period based on the second setting signal.

In some embodiments, an initial preset time period is preset by the operation system.

Referring back to FIG. 2A, in step 202, when the mobile terminal detects that an operation system is being upgraded/updated with an application installation package, the mobile terminal determines whether the application installation package is included in an upgrade compilation list.

For example, n application installation packages are to be compiled during the upgrade/update in the mobile terminal, where n is a positive integer.

If the application installation packages for the operation system have been compiled in a server, the n application installation packages to be compiled include: third-party application installation packages of applications installed by the user.

If the application installation packages for the operation system have not been compiled in a server, the n application installation packages to be compiled include: the application installation packages for the operation system, and third-party application installation packages of applications installed by the user.

In the illustrated embodiment, the mobile terminal determines whether the n application installation packages are included in an upgrade compilation list.

If it is determined that an application installation package is included in the upgrade compilation list, the method 200 proceeds to step 203. If it is determined that an application installation package is not included in the upgrade compilation list, the method 200 proceeds to step 204.

In step 203, the application installation package having the upgrade compilation attribute is compiled.

When the application installation package is in the upgrade compilation list, the mobile terminal determines that the processing attribute of the application installation package is the upgrade compilation attribute, and compiles the application installation package into a binary code file which can be executed by the mobile terminal with higher efficiency.

In step 204, the mobile terminal determines whether a time period between the time the application program corresponding to the application installation package was last used and a current time exceeds a preset time period.

If the time period does not exceed the preset time period, then the application corresponding to the application installation package is a frequently-used application program. The mobile terminal determines that the processing attribute of the application installation package is the upgrade compilation attribute. The method 200 proceeds to step 203.

If the time period exceeds the preset time period, then the mobile terminal determines that the processing attribute of the application installation package is the idle compilation attribute. The method 200 proceeds to step 205.

In step 205, the mobile terminal postpones the compilation of the application installation package.

In some embodiments, after all of the n application installation packages have been processed in steps 201-205, the mobile terminal ends the current upgrade at step 205.

In step 206, after the upgrade ends, the mobile terminal detects whether a current operation state of the mobile terminal satisfies an idle compilation condition.

After ending the current upgrade/update, the mobile terminal may detect whether a current operation state satisfies an idle compilation condition. The idle compilation condition includes at least one of the following conditions:

a current time falls within an idle time period;

a current battery power exceeds a preset threshold;

a current state is a battery charging state; or

no operating signal is received in a most recent time period.

For example, an idle compilation condition includes that the current time falls within 11:30 pm to 6:00 am, that the current battery power exceeds 50%, and that no operating signal is received in the last 10 minutes.

In step 207, if the current operation state of the mobile terminal satisfies the idle compilation condition, the application installation package having the idle compilation attribute is compiled.

When it is conformed that current operation state of the mobile terminal satisfies the idle compilation condition, the mobile terminal proceeds to compile the application installation package having the idle compilation attribute. If current operation state of the mobile terminal does not satisfy the idle compilation condition, the mobile terminal maintains the current operation state without compiling the postponed application installation package.

In one embodiment, an operating signal is received during compiling the application installation package having the idle compilation attribute. After the mobile terminal completes compiling the application installation package, the mobile terminal temporarily suspends the compilation of other application installation packages that have not been compiled, and waits for the next timing when the operation state of the mobile terminal again satisfies the idle compilation condition, to proceed to compile.

In step 208, the mobile terminal receives a start signal to start an application installation package.

After the automatic upgrade ends, the user may also manually start the application installation package to install updates/upgrades.

In step 209, the mobile terminal detects whether an application installation package is not compiled and whether the processing attribute of the application installation package is the idle compilation attribute.

In step 210, if the application installation package has been compiled, then the mobile terminal starts the application installation package to install updates/upgrades.

In step 211, if the application installation package is not compiled yet and its processing attribute is the idle compilation attribute, then the mobile terminal compiles the application installation package, and starts the application installation package after it is compiled.

In some embodiments, during compiling the application installation package, the mobile terminal may display a guide interface, which is used to prompt the user to wait for the completion of the compiling.

For example, FIG. 3C illustrates the mobile terminal 300 having the display 302 displaying a guide interface 308. As shown in FIG. 3C, during compiling, the mobile terminal displays a dialog box 34, having a prompt message “optimizing and compiling, please wait . . . ”.

In the illustrated embodiment, some application installation packages are compiled during an upgrade/update session, while others are put on hold until a later time to reduce the time for upgrading and updating in which the user's use of the mobile terminal is impacted, so as to improve the user experience.

In the illustrated method 200, when the current operation state of the mobile terminal satisfies the idle compilation condition, the mobile terminal proceeds to automatically compile the application installation packages having the idle compilation attribute that are put on hold for compilation. The method 200 reduce the impact that some applications may not function properly because their corresponding application installation packages are not compiled during the upgrade session, and allows the mobile terminal to sufficiently use the idle time of the mobile terminal to perform compilation and improve utilization of the resource.

In the illustrated method 200, when the user needs to use the application installation package, if the current application installation package is not compiled and its processing attribute is the idle compilation attribute, then the application installation package is compiled instantly. Since the time for compiling a single application installation package is limited, the user's use of the application installation package is not affected.

The present disclosure further provides apparatuses for processing application installation packages. The apparatuses consistent with embodiments of the present disclosure may be used to perform the methods explained above. Details of the apparatuses that are not disclosed hereafter may be referred to the above methods.

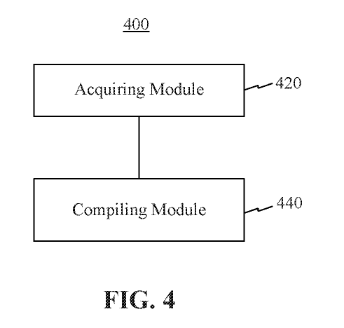

FIG. 4 is a block diagram illustrating an apparatus 400 for processing application installation packages according to an exemplary embodiment. The apparatus 400 may be implemented via software, hardware, or a combination of software and hardware as all or a part of a mobile terminal. As shown in FIG. 4, The apparatus 400 includes an acquiring module 420 and a compiling module 440.

The acquiring module 420 is configured to acquire a processing attribute of an application installation package when the mobile terminal detects that an operation system is being upgraded with the application installation package. The processing attribute includes one of an upgrade compilation attribute or an idle compilation attribute.

The compiling module 440 is configured to, during upgrade of the operation system, compile the application installation package(s) having the upgrade compilation attribute.

In the illustrated embodiments, application installation packages having the upgrade compilation attribute are compiled during upgrade. The apparatus 400 reduces the processing time by compiling selected application installation packages as to shorten the upgrade time, reduce the impact on the user's use of the mobile terminal, and improve the user experience.

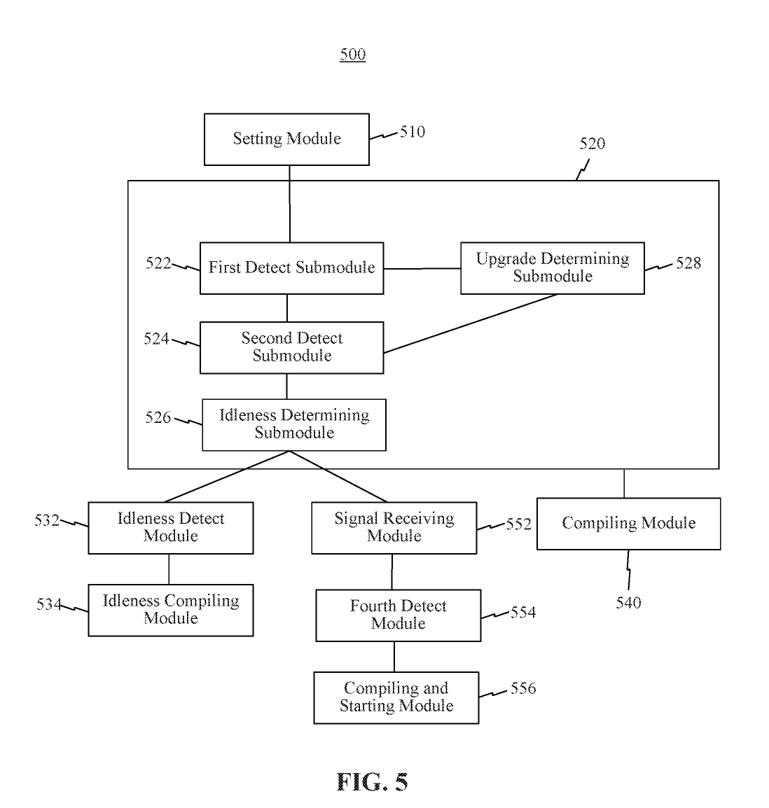

FIG. 5 is a block diagram illustrating an apparatus 500 for processing an application installation package according to an exemplary embodiment. The apparatus 500 may be implemented via software, hardware or a combination of software and hardware as all or a part of a mobile terminal. As shown in FIG. 5, the apparatus 500 for processing an application installation package includes an acquiring module 520 and a compiling module 540.

The acquiring module 520 is configured to acquire a processing attribute of an application installation package when the mobile terminal detects that an operation system is being upgraded with the application installation package. The processing attribute includes one of an upgrade compilation attribute or an idle compilation attribute.

The compiling module 540 is configured to, during upgrade of the operation system, compile the application installation package(s) having the upgrade compilation attribute.

In some embodiments, the acquiring module 520 includes: a first detect submodule 522, a second detect submodule 524, an idleness determining submodule 526, and an upgrade determining submodule 528.

The first detect submodule 522 is configured to determine whether the application installation package is included in an upgrade compilation list.

The second detect submodule 524 is configured to, when the application installation package is not included in the upgrade compilation list, determine whether a time period between the time the application program corresponding to the application installation package was last used and a current time exceeds a preset time period.

The idleness determining submodule 526, configured to, when the time period exceeds the preset time period, determine that the processing attribute of the application installation package is the idle compilation attribute.

The upgrade determining submodule 528, configured to, when the application installation package is included in the upgrade compilation list or the time period does not exceed the preset time period, determine that the processing attribute of the application installation package is the upgrade compilation attribute.

In some embodiments, the apparatus 500 further includes: an idleness detect module 532 and an idleness compiling module 534.

The idleness detect module 532 is configured to detect whether a current operation state satisfies an idle compilation condition.

The idleness compiling module 534 is configured to, when the current operation state satisfies the idle compilation condition, compile the application installation package having the idle compilation attribute.

In some embodiments, the idle compilation condition includes at least one of the following conditions:

a current time falls within an idle time period;

a current battery power exceeds a preset threshold;

a current state is a battery charging state; or

no operating signal is received in a most recent time period.

In some embodiments, the apparatus 500 further includes: a signal receiving module 552, a fourth detect module 554, and a compiling and starting module 556.

The signal receiving module 552 is configured to receive a start signal which corresponds to the application installation package.

The fourth detect module 554 is configured to detect whether the application installation package is not compiled and the processing attribute of the application installation package is the idle compilation attribute.

The compiling and starting module 556 is configured to, when the application installation package is not compiled and its processing attribute is the idle compilation attribute, compile the application installation package, and start to install the application installation package after the compiling is completed.

In some embodiments, the apparatus 500 further includes a setting module 510, configured to preset the processing attribute of the application installation package based on an importance level of the application installation package.

In the illustrated embodiment, some application installation packages are compiled during an upgrade/update session, while others are put on hold until a later time to reduce the time for upgrading and updating in which the user's use of the mobile terminal is impacted, so as to improve the user experience.

In the illustrated embodiment, when the current operation state of the mobile terminal satisfies the idle compilation condition, the apparatus 500 proceeds to automatically compile the application installation packages having the idle compilation attribute that are put on hold for compilation. The apparatus 500 reduces the impact that some applications may not function properly because their corresponding application installation packages are not compiled during the upgrade session, and allows the apparatus 500 to sufficiently use the idle time of the apparatus 500 to perform compilation and improve utilization of the resource.

In the illustrated embodiment, when the user needs to use the application installation package, if the current application installation package is not compiled and its processing attribute is the idle compilation attribute, then the application installation package is compiled instantly. Since the time for compiling a single application installation package is limited, the user's use of the application installation package is not affected.

With respect to the apparatuses in the above embodiments, the specific implementations of operations executed by various modules or submodules thereof have been explained in detail described in the embodiments illustrating the methods, which are not described herein any further.

An apparatus for processing an application installation package consistent with embodiments of the present disclosure, includes: a processor, and a memory for storing instructions executable by the processor.

The processor is configured to: acquire a processing attribute of an application installation package when the mobile terminal detects that an operation system is being upgraded with the application installation package, the processing attribute including one of an upgrade compilation attribute or an idle compilation attribute, and during upgrade of the operation system, compile the application installation package(s) having the upgrade compilation attribute,

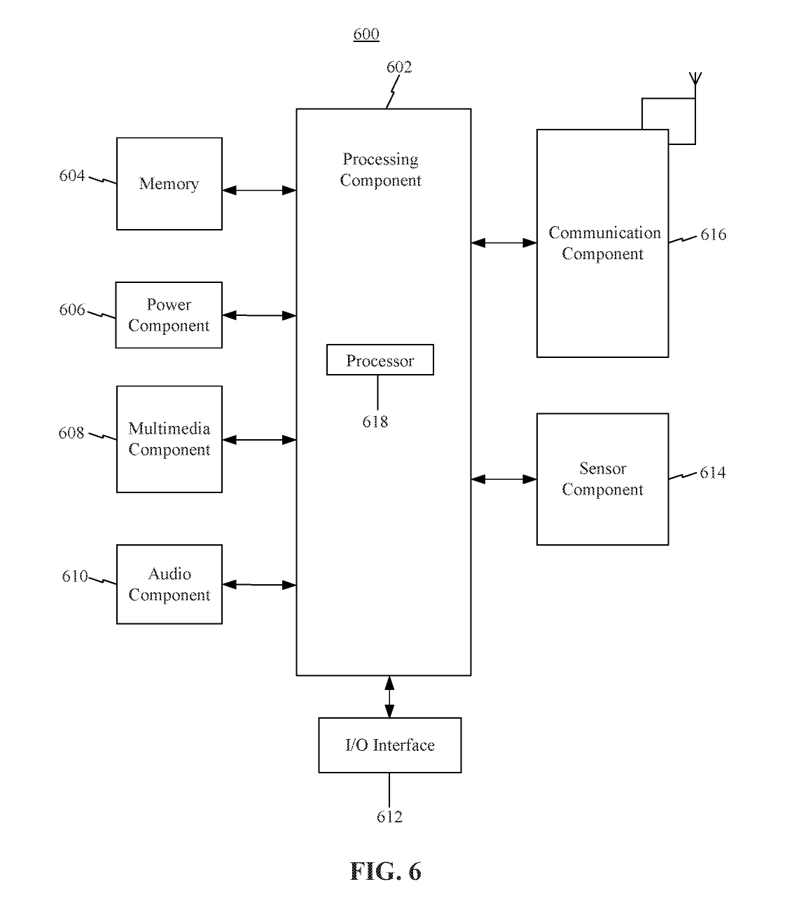

FIG. 6 is a block diagram illustrating an apparatus 600 for processing an application installation package according to an exemplary embodiment. For example, the apparatus 600 may be a mobile phone, a computer, a digital broadcast terminal, a messaging device, a gaming console, a tablet, a medical device, exercise equipment, a personal digital assistant, and the like.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 618 to execute instructions to perform all or a part of the steps in the above-described methods. In addition, the processing component 602 may include one or more modules which facilitate the interaction between the processing component 602 and other components. For example, the processing component 602 may include a multimedia module to facilitate the interaction between the multimedia component 608 and the processing component 602.

The memory 604 is configured to store various types of data to support the operations of the apparatus 600. Examples of such data include instructions for any application or method operated on the apparatus 600, contact data, phonebook data, messages, pictures, videos, and the like. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power management system, one or more power supplies, and other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and/or the rear camera may receive external multimedia data while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive an external audio signal when the apparatus 600 is in an operation mode, such as a call mode, a recording mode, or a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and a peripheral interface module, such as a keyboard, a click wheel, a button, or the like. The buttons may include, but are not limited to, a home button, a volume button, a starting button, and a locking button.

The sensor component 614 includes one or more sensors to provide status assessments of various aspects of the apparatus 600. For example, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communications, wired or wirelessly, between the apparatus 600 and other devices. The apparatus 600 may access a wireless network based on a communication standard, such as WiFi, 3G or 4G or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 604, executable by the processor 618 in the apparatus 600, for performing the above-described methods for compiling applications. For example, the non-transitory computer-readable storage medium may be a ROM, a random access memory (RAM), a compact disc read-only memory (CD-ROM), a magnetic tape, a floppy disc, an optical data storage device, or the like.

There is provided a non-transitory computer-readable storage medium having stored therein instructions that, when executed by a processor of a mobile terminal, cause the mobile terminal to perform all or some steps of methods 100 and 200.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claimed is:

1. A method for processing an application installation package, comprising:
acquiring a processing attribute of the application installation package when it is detected that an operation system of a mobile terminal is being upgraded with the application installation package, the processing attribute including one of an upgrade compilation attribute or an idle compilation attribute; and
during upgrade of the operation system, compiling the application installation package having the upgrade compilation attribute.

2. The method according to claim 1, wherein the acquiring a processing attribute of the application installation package comprises:
determining whether the application installation package is included in an upgrade compilation list;
when the application installation package is not included in the upgrade compilation list, determining whether a time period between a time the application program corresponding to the application installation package is last used and a current time exceeds a preset time period;
when the time period exceeds the preset time period, determining that the processing attribute of the application installation package is the idle compilation attribute; and
when the application installation package is included in the upgrade compilation list or the time period does not exceed the preset time period, determining that the processing attribute of the application installation package is the upgrade compilation attribute.

3. The method according to claim 1, further comprising:
detecting whether a current operation state satisfies an idle compilation condition; and
when the current operation state satisfies the idle compilation condition, compiling the application installation package having the idle compilation attribute.

4. The method according to claim 3, wherein the idle compilation condition comprises at least one of the following conditions:
a current time within an idle time period;
a current battery power exceeding a preset threshold;
a current state being a battery charging state; or
no operating signal received in a most recent time period.

5. The method according to claim 1, further comprising:
receiving a start signal which corresponds to the application installation package;
detecting whether the application installation package is not compiled and the processing attribute of the application installation package is the idle compilation attribute; and
when the application installation package is not compiled and its processing attribute is the idle compilation attribute, compiling the application installation package, and starting to install the application installation package on the mobile terminal after the compiling is completed.

6. The method according to claim 1, further comprising:
presetting the processing attribute of the application installation package based on an importance level of the application installation package.

7. An apparatus for processing an application installation package, comprising:
a processor; and
a memory for storing instructions executable by the processor,
wherein the processor is configured to:
acquire a processing attribute of the application installation package when it is detected that an operation system of a mobile terminal is being upgraded with the application installation package, the processing attribute including one of an upgrade compilation attribute or an idle compilation attribute; and
during upgrade of the operation system, compile the application installation package having the upgrade compilation attribute.

8. The apparatus according to claim 7, wherein the processor is further configured to:
determine whether the application installation package is included in an upgrade compilation list;
when the application installation package is not included in the upgrade compilation list, determine whether a time period between a time the application program corresponding to the application installation package is last used and a current time exceeds a preset time period;
when the time period exceeds the preset time period, determine that the processing attribute of the application installation package is the idle compilation attribute; and
when the application installation package is included in the upgrade compilation list or the time period does not exceed the preset time period, determine that the processing attribute of the application installation package is the upgrade compilation attribute.

9. The apparatus according to claim 7, wherein the processor is further configured to:
detect whether a current operation state satisfies an idle compilation condition; and
when the current operation state satisfies the idle compilation condition, compile the application installation package having the idle compilation attribute.

10. The apparatus according to claim 9, wherein the idle compilation condition comprises at least one of the following conditions:
a current time within an idle time period;
a current battery power exceeding a preset threshold;
a current state being a battery charging state; or
no operating signal received in a most recent time period.

11. The apparatus according to claim 7, wherein the processor is further configured to:
receive a start signal which corresponds to the application installation package;
detect whether the application installation package is not compiled and the processing attribute of the application installation package is the idle compilation attribute; and
when the application installation package is not compiled and its processing attribute is the idle compilation attribute, compile the application installation package, and start to install the application installation package on the mobile terminal after the compiling is completed.

12. The apparatus according to claim 7, wherein the processor is further configured to:
preset the processing attribute of the application installation package based on an importance level of the application installation package.

13. A non-transitory computer-readable storage medium having stored therein instructions that, when executed by one or more processors of an apparatus, cause the apparatus to perform:
acquiring a processing attribute of the application installation package when it is detected that an operation system of a mobile terminal is being upgraded with the application installation package, the processing attribute including one of an upgrade compilation attribute or an idle compilation attribute; and
during upgrade of the operation system, compiling the application installation package having the upgrade compilation attribute.
